(19) United States
(12) Patent Application Publication
(10) Pub. No.: US 2022/0393894 A1
(43) Pub. Date: Dec. 8, 2022

(54) IN-VEHICLE COMMUNICATION SYSTEM, IN-VEHICLE COMMUNICATION DEVICE, AND VEHICLE COMMUNICATION METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yuanjun XIAN, Yokkaichi-shi, Mie (JP); Takeshi HAGIHARA, Yokkaichi-shi, Mie (JP); Makoto MASHITA, Yokkaichi-shi, Mie (JP); Nobuyuki KOBAYASHI, Yokkaichi-shi, Mie (JP); Takehiro KAWAUCHI, Osaka-shi, Oaska (JP); Tatsuya IZUMI, Osaka-shi, Oaska (JP); Akihito WATA, Osaka-shi, Oaska (JP); Yusuke YAMAMOTO, Osaka-shi, Oaska (JP)

(21) Appl. No.: 17/755,490

(22) PCT Filed: Aug. 13, 2020
(86) PCT No.: PCT/JP2020/030768

§ 371 Date: Apr. 29, 2022

(30) Foreign Application Priority Data
Oct. 31, 2019 (JP) 2019-199092

(51) Int. Cl. H04L 12/12; H04L 12/28; H04L 67/12

(52) U.S. Cl. CPC H04L 12/12; H04L 12/28; H04L 67/12; H04L 2012/40273

(57) ABSTRACT

An in-vehicle communication system, comprises: a first in-vehicle communication device and a second in-vehicle communication device transmitting and receiving a signal to and from each other by a predetermined communication protocol related to Ethernet® (registered trademark), wherein the first in-vehicle communication device includes a PHY unit having a communication circuit, and a determination processing unit for determining whether or not the second in-vehicle communication device is in a link-down sleep state, when determined that the second in-vehicle communication device is in the sleep state, the PHY unit outputs a predetermined signal to the second in-vehicle communication device, and the second in-vehicle communication device includes a PHY unit having a communication circuit, a detection circuit for detecting the predetermined signal input to the PHY unit, and a power supply circuit for waking up the PHY unit when the detection circuit detects the predetermined signal.

### CROSS-REFERENCE TO RELATED APPLICATIONS

This application is the U.S. national stage of PCT/JP2020/030768 filed on Aug. 13, 2020, which claims priority of Japanese Patent Application No. JP 2019-199092 filed on Oct. 31, 2019, the contents of which are incorporated herein.

### TECHNICAL FIELD

The present disclosure relates to an in-vehicle communication system, an in-vehicle communication device, and a vehicle communication method.

### BACKGROUND

In recent years, in-vehicle Ethernet® has been attracting attention. An in-vehicle communication device that performs Ethernet® communication includes a PHY unit that transmits and receives signals via a port. The PHY unit compliant with 100BaseT1 (IEEE802.3bw) includes a detection circuit for detecting an idle signal input to the port, in addition to a transmission circuit and a reception circuit.

In 100BaseT1, there are a master and a slave, and an in-vehicle communication device which is the master outputs an idle signal before linking up. When the PHY unit is in a link-down sleep state, and the idle signal output from the master is detected by the detection circuit, an in-vehicle communication device which is the slave can wake up the PHY unit from the sleep state (Non-Patent Document 1).

When the master in-vehicle communication device is in the sleep state, the idle signal is not output from the slave in-vehicle communication device, and thus there is a problem that the master in-vehicle communication device cannot be woken up.

### SUMMARY

An object of the disclosure is to provide an in-vehicle communication system, an in-vehicle communication device, and a vehicle communication method capable of waking up a master in-vehicle communication device in a sleep state from a slave in-vehicle communication device compliant with a predetermined communication protocol related to Ethernet®.

An in-vehicle communication system of the present disclosure is the in-vehicle communication system, comprising: a first in-vehicle communication device and a second in-vehicle communication device transmitting and receiving a signal to and from each other by a predetermined communication protocol related to Ethernet®, wherein the first in-vehicle communication device includes a port, a signal being input to and output from the port, a first PHY unit having a first communication circuit for transmitting and receiving a signal via the port, and a determination processing unit for determining whether or not the second in-vehicle communication device is in a link-down sleep state, when the determination processing unit determines that the second in-vehicle communication device is in the sleep state, the first PHY unit outputs a predetermined signal to the second in-vehicle communication device via the port, and the second in-vehicle communication device includes a port, a signal being input to and output from the port, a second PHY unit having a second communication circuit for transmitting and receiving a signal via the port, a detection circuit for detecting the predetermined signal input to the port, and a power supply circuit for waking up the second communication circuit when the detection circuit detects the predetermined signal.

An in-vehicle communication device of the present disclosure is the in-vehicle communication device, comprising: a port, a signal being input to and output from the port; a PHY unit having a communication circuit for transmitting and receiving a signal via the port; and a determination processing unit for determining whether or not an external in-vehicle communication device connected to the port is in a link-down sleep state, wherein when the determination processing unit determines that the external in-vehicle communication device is in the sleep state, the PHY unit outputs a predetermined signal to the external in-vehicle communication device via the port.

A vehicle communication method of the present disclosure is the vehicle communication method using a first in-vehicle communication device and a second in-vehicle communication device transmitting and receiving a signal to and from each other by a predetermined communication protocol related to Ethernet®, wherein the first in-vehicle communication device determines whether or not the second in-vehicle communication device is in a link-down sleep state, and outputs a predetermined signal to the second in-vehicle communication device when it is determined that the second in-vehicle communication device is in a sleep state, and the second in-vehicle communication device detects the input predetermined signal, and wakes up a communication circuit of the second in-vehicle communication device when the predetermined signal is detected.

Note that this application can be realized not only as an in-vehicle communication system and an in-vehicle communication device including such a characteristic processing unit, but also as a vehicle communication method in which such characteristic processing is a step as described above or as a program for causing a computer to execute such a step. In addition, this application can be realized as a semiconductor integrated circuit that realizes a part of or the entire in-vehicle communication system, or as another system including the in-vehicle communication system.

### ADVANTAGEOUS EFFECTS

According to the disclosure, it is possible to provide an in-vehicle communication system, an in-vehicle communication device, and a vehicle communication method capable of waking up a master in-vehicle communication device in a sleep state from a slave in-vehicle communication device compliant with a predetermined communication protocol related to Ethernet®.

### BRIEF DESCRIPTION OF THE DRAWINGS

FIG. 1 is a block diagram illustrating a configuration example of an in-vehicle communication system according to a first embodiment.

FIG. 2 is a flowchart illustrating a wake-up method of a master according to the first embodiment.

FIG. 3 is a timing diagram illustrating an output timing of a predetermined signal.

FIG. 4 is a block diagram illustrating a configuration example of an in-vehicle communication system according to a second embodiment.

FIG. 5 is a flowchart illustrating a wake-up method of a master according to the second embodiment.

### DETAILED DESCRIPTION OF PREFERRED EMBODIMENTS

First, embodiments of the disclosure will be listed and described. In addition, at least a part of the embodiments described below may be arbitrarily combined.

An in-vehicle communication system of the present aspect is the in-vehicle communication system, comprising: a first in-vehicle communication device and a second in-vehicle communication device transmitting and receiving a signal to and from each other by a predetermined communication protocol related to Ethernet®, wherein the first in-vehicle communication device includes a port, a signal being input to and output from the port, a first PHY unit having a first communication circuit for transmitting and receiving a signal via the port, and a determination processing unit for determining whether or not the second in-vehicle communication device is in a link-down sleep state, when the determination processing unit determines that the second in-vehicle communication device is in the sleep state, the first PHY unit outputs a predetermined signal to the second in-vehicle communication device via the port, and the second in-vehicle communication device includes a port, a signal being input to and output from the port, a second PHY unit having a second communication circuit for transmitting and receiving a signal via the port, a detection circuit for detecting the predetermined signal input to the port, and a power supply circuit for waking up the second communication circuit when the detection circuit detects the predetermined signal.

According to this aspect, the first in-vehicle communication device can determine whether or not the PHY unit of the second in-vehicle communication device is in the sleep state by the determination processing unit. When the PHY unit of the second in-vehicle communication device is in the sleep state, the PHY unit of the first in-vehicle communication device outputs the predetermined signal to the second in-vehicle communication device. When the PHY unit of the second in-vehicle communication device is not in the sleep state, if the predetermined signal is transmitted to the second in-vehicle communication device, a problem may occur. Therefore, it is necessary to determine whether or not the PHY unit of the second in-vehicle communication device is in the sleep state.

The second in-vehicle communication device can detect the predetermined signal output from the first in-vehicle communication device by the detection circuit, and when the predetermined signal is detected, the power supply circuit supplies electric power to the communication circuit of the PHY unit to wake up the communication circuit.

Therefore, the first in-vehicle communication device can transmit the predetermined signal after verifying whether or not the communication circuit of the second in-vehicle communication device is in the sleep state, and wake up the communication circuit of the second in-vehicle communication device.

It is preferable that the predetermined communication protocol is 100Base-T1, the first in-vehicle communication device is a slave in the predetermined communication protocol, and the second in-vehicle communication device is a master in the predetermined communication protocol.

According to this aspect, the first in-vehicle communication device and the second in-vehicle communication device perform communication compliant with 100Base-T1. The slave in-vehicle communication device can wake up the communication circuit of the master in-vehicle communication device in the sleep state.

It is preferable that the predetermined signal is a pattern signal substantially the same as an idle signal in the predetermined communication protocol.

According to this aspect, the slave in-vehicle communication device can output a pattern signal substantially the same as an idle signal to be transmitted from the master side as a predetermined signal to the master in-vehicle communication device, and wake up the communication circuit of the master. The detection circuit included in the master in-vehicle communication device is for detecting an idle signal transmitted from the master side when the in-vehicle communication device operates as a slave. Therefore, the detection circuit can reliably detect the predetermined signal substantially the same as the idle signal. Therefore, by using the predetermined signal substantially the same as the idle signal, the master in-vehicle communication device can more reliably detect the predetermined signal transmitted from the slave to wake up the communication circuit of the master.

It is preferable that when no signal is received from the second in-vehicle communication device for a first predetermined time, the determination processing unit determines that the second in-vehicle communication device is in a sleep state, and the first PHY unit outputs the predetermined signal during a second predetermined time related to reception of the predetermined signal by the detection circuit.

According to this aspect, the first in-vehicle communication device monitors a state of the second in-vehicle communication device for the first predetermined time, and when a signal transmitted from the second in-vehicle communication device is not received, it is determined that the second in-vehicle communication device is in the sleep state. The first predetermined time is a longest time during which a link-up PHY unit does not transmit a signal.

The first in-vehicle communication device outputs the predetermined signal to the second in-vehicle communication device for the second predetermined time. The second predetermined time is a time required for the detection device to reliably detect the predetermined signal.

It is preferable that the first in-vehicle communication device is a relay device.

According to this aspect, the first in-vehicle communication device is a relay device, and the second in-vehicle communication device is a communication device connected to the relay device. Therefore, the communication circuit of the second in-vehicle communication device connected to the relay device can be woken up from the relay device side.

It is preferable that the second in-vehicle communication device includes a plurality of second PHY units, and when the detection circuit detects the predetermined signal input to a port of one of the second PHY units, the power supply circuit wakes up a communication circuit of the one second PHY unit and a communication circuit of another second PHY unit or a plurality of other second PHY units.

According to this aspect, when a predetermined signal output to one PHY unit is detected, the second in-vehicle communication device can wake up the communication circuit of not only the one PHY unit but also another PHY unit or a plurality of other PHY units. Therefore, it is unnecessary to individually wake up each of the communication circuits of the plurality of PHY units included in the second in-vehicle communication device, and it is possible to collectively wake up the plurality of PHY units.

An in-vehicle communication device of the present aspect is the in-vehicle communication device, comprising: a port, a signal being input to and output from the port; a PHY unit having a communication circuit for transmitting and receiving a signal via the port; and a determination processing unit for determining whether or not an external in-vehicle communication device connected to the port is in a link-down sleep state, wherein when the determination processing unit determines that the external in-vehicle communication device is in the sleep state, the PHY unit outputs a predetermined signal to the external in-vehicle communication device via the port.

According to this aspect, the in-vehicle communication device can transmit the predetermined signal after verifying whether or not another in-vehicle communication device connected to the port is in the sleep state, and wake up the communication circuit of another in-vehicle communication device.

A vehicle communication method of the present aspect is the vehicle communication method using a first in-vehicle communication device and a second in-vehicle communication device transmitting and receiving a signal to and from each other by a predetermined communication protocol related to Ethernet®, wherein the first in-vehicle communication device determines whether or not the second in-vehicle communication device is in a link-down sleep state, and outputs a predetermined signal to the second in-vehicle communication device when it is determined that the second in-vehicle communication device is in a sleep state, and the second in-vehicle communication device detects the input predetermined signal, and wakes up a communication circuit of the second in-vehicle communication device when the predetermined signal is detected.

According to this aspect, as in the first aspect, the first in-vehicle communication device can transmit the predetermined signal after verifying whether or not the communication circuit of the second in-vehicle communication device is in the sleep state, and wake up the communication circuit of the second in-vehicle communication device.

An in-vehicle communication system according to embodiments of the disclosure will be described below with reference to the drawings. Note that the invention is not limited to these examples, is indicated by the scope of claims, and is intended to include equivalents of the claims and all modifications within the scope.

Hereinafter, the disclosure will be specifically described with reference to the drawings illustrating the embodiments thereof.

### First Embodiment

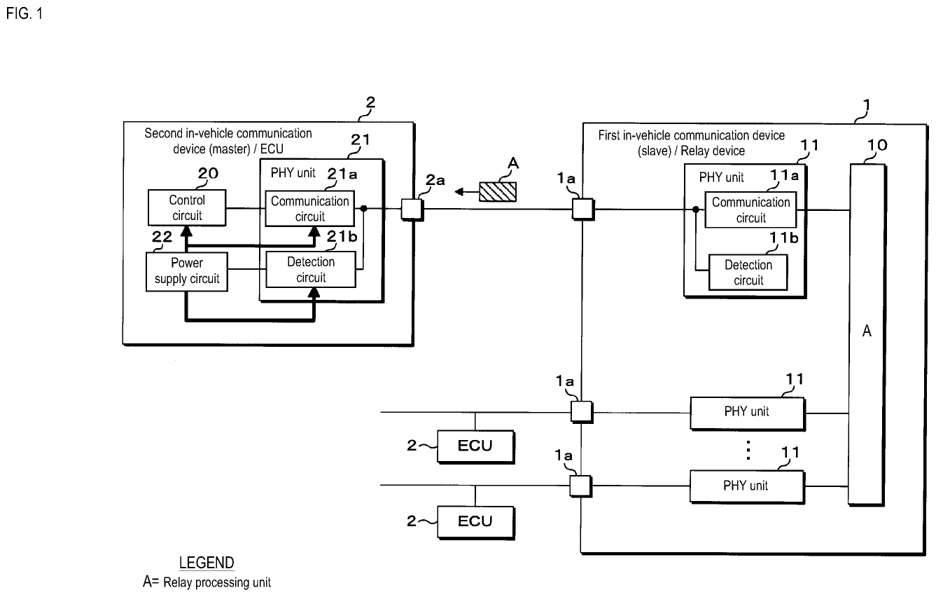

FIG. 1 is a block diagram illustrating a configuration example of an in-vehicle communication system according to a first embodiment. In FIG. 1, a thick line indicates a feeder line, and a thin line indicates a signal line. The in-vehicle communication system according to the first embodiment includes a relay device 1 mounted on a vehicle and a plurality of ECUs (Electronic Control Units) 2. The plurality of ECUs 2 is connected to the relay device 1 by an in-vehicle communication line to form an in-vehicle Ethernet®. Note that the in-vehicle communication system may be configured to perform CAN communication together with Ethernet® communication.

The relay device 1 includes a relay processing unit 10, a plurality of ports 1a, and a plurality of PHY units 11 transmitting and receiving signals via each of the ports 1a. The relay device 1 is a first in-vehicle communication device that performs communication compliant with 100BaseT1 (IEEE802.3bw), and functions as a slave.

The PHY unit 11 includes a communication circuit 11a and a detection circuit 11b. Since configurations of the plurality of PHY units 11 included in the relay device 1 are the same, a configuration of one PHY unit 11 will be described below, and the detailed description of the other PHY units 11 will be omitted.

The communication circuit 11a includes a transmission circuit and a reception circuit functioning as a transceiver that performs communication compliant with the communication protocol of 100Base-T1. The transmission circuit converts transmission data given from the relay processing unit 10 into a three-level signal and outputs the converted three-level signal to the port 1a. The signal is transmitted to the ECU 2 connected to the port 1a via the port 1a. Further, the transmission circuit converts the signal transmitted from the ECU 2 and input to the port 1a into reception data, and gives the converted reception data to the relay processing unit 10. The PHY unit 11 on the slave side according to the first embodiment has a function of outputting a predetermined signal A for wake-up of the link-down PHY unit 11 on the master side. The predetermined signal A is, for example, a pattern signal substantially the same as an idle signal to be output from the master when the master in 100BaseT1 links up. Note that the pattern signal is an example of the predetermined signal A, and may be a signal having another arbitrary waveform as long as the signal is a signal that can be detected by a detection circuit 21b of the master.

When an idle signal transmitted from the master in-vehicle communication device, for example, the ECU 2 is input to the PHY unit 11 via the port 1a, the detection circuit 11b detects the idle signal. When the detection circuit 11b detects the idle signal, the detection circuit 11b outputs a signal for waking up a communication circuit 21a in a sleep state. In the first embodiment, since an operation of the detection circuit 21b on the master ECU 2 side is important, the details of the detection circuit 11b on the slave side will be omitted.

The plurality of ECUs 2 is connected to the relay processing unit 10 to have functions as an Ethernet® switch and an L2 switch for relaying transmission data and reception data. The relay processing unit 10 includes, for example, a microcomputer, a storage unit, an input/output interface to which the PHY unit 11 is connected, a timekeeping unit, etc. (not illustrated), and executes relay processing of transmission data.

Further, the relay processing unit 10 has a function of monitoring a signal transmitted from the ECU 2 and determining whether or not the ECU 2 is in a sleep state.

The ECU 2 includes a control circuit 20, a port 2a, a PHY unit 21 for transmitting and receiving signals via the port 2a, and a power supply circuit 22. The ECU 2 is a second in-vehicle communication device that performs communication compliant with 100BaseT1 (IEEE802.3bw), and functions as a master.

The PHY unit 21 includes the communication circuit 21a and the detection circuit 21b.

The communication circuit 21a includes a transmission circuit and a reception circuit functioning as a transceiver that performs communication compliant with the communication protocol of 100Base-T1. The transmission circuit converts transmission data given from the control circuit 20 into a three-level signal and outputs the converted three-level signal to the port 2a. The signal is transmitted to another ECU 2 through the relay device 1 connected to the port 2a. Further, the transmission circuit converts a signal transmitted from another ECU 2 via the relay device 1 and input to the port 2a into reception data, and gives the converted reception data to the control circuit 20.

When the predetermined signal A transmitted from the slave relay device 1 is input to the PHY unit 21 via the port 2a, the detection circuit 21b detects the predetermined signal A. When the detection circuit 21b detects the predetermined signal A output from the slave relay device 1, the detection circuit 21b outputs a predetermined power supply instruction signal to the power supply circuit 22.

The power supply circuit 22 is a circuit that supplies electric power to the control circuit 20, the communication circuit 21a, and the detection circuit 21b. A power supply path from the power supply circuit 22 to the detection circuit 21b is different from a power supply path to the control circuit 20 and the communication circuit 21a. When the power supply circuit 22 receives a power supply suspension command from the control circuit 20, the power supply circuit 22 suspends power supply to the communication circuit 21a of the PHY unit 21 and links down the communication circuit 21a. Note that the power supply circuit 22 may suspend power supply to the control circuit 20 together with the communication circuit 21a. However, even when power supply to the communication circuit 21a is suspended, the power supply circuit 22 does not suspend power supply to the detection circuit 21b and continuously supplies electric power. That is, the detection circuit 21b is in operation at all times and is in a state where the predetermined signal A output from the relay device 1 can be constantly detected.

The power supply circuit 22 starts power supply to the communication circuit 21a when power supply to the communication circuit 21a is suspended and the predetermined power supply instruction signal is output from the detection circuit 21b. The communication circuit 21a supplied with electric power from the power supply circuit 22 wakes up, performs a link-up process, and starts communication as a master.

Note that a function of the ECU 2 is not particularly limited, and includes the following. An ECU 2 belonging to a cognitive domain is connected to, for example, a sensor such as an in-vehicle camera, LIDAR, an ultrasonic sensor, or a millimeter wave sensor. The ECU 2 digitally converts an output value output from the sensor, for example, and transmits the output value to an ECU 2 of a determination system domain via the relay device 1. The ECU 2 belonging to the determination system domain receives, for example, data transmitted from the ECU 2 belonging to the cognitive system domain. Based on the received data, the ECU 2 of the determination system domain generates data for exhibiting an automatic driving function of a vehicle, or performs a process of processing the data. The ECU 2 of the determination system domain transmits the generated data to an ECU 2 of an operation system domain via the relay device 1.

The ECU 2 belonging to the operation system domain is connected to, for example, an actuator such as a motor, an engine, or a brake. The ECU 2 of the operation system domain receives data transmitted from the ECU 2 of the determination system domain, controls an operation of the actuator based on the received data to perform an operation such as running, stopping, or steering the vehicle, and exhibits the automatic driving function.

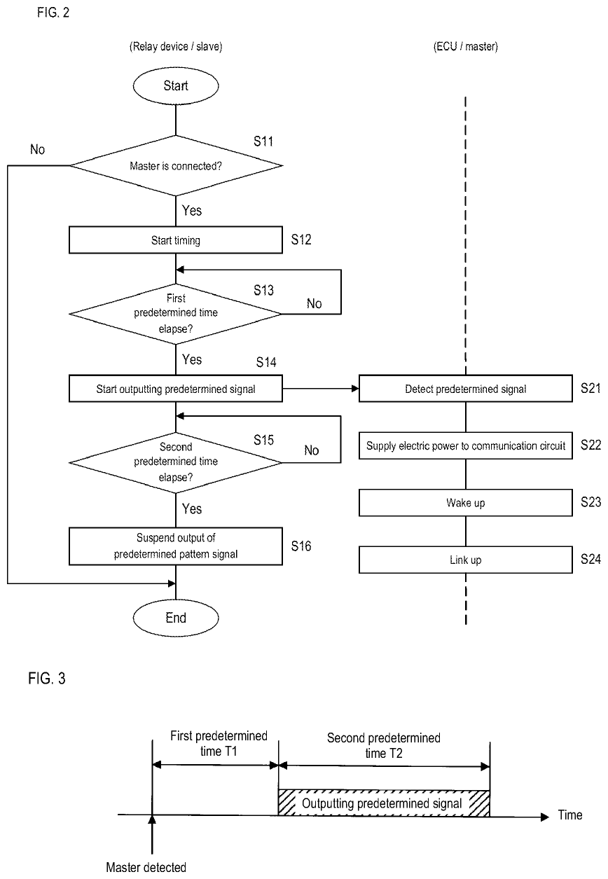

FIG. 2 is a flowchart illustrating a wake-up method of the master according to the first embodiment, and FIG. 3 is a timing diagram illustrating an output timing of the predetermined signal A.

The relay processing unit 10 of the slave relay device 1 determines whether or not the master ECU 2 is connected to one port 1a (step S11).

When it is determined that the ECU 2 is not connected to the port 1a (step S11: NO), the relay processing unit 10 ends the processing.

When it is determined that the master ECU 2 is connected to the port 1a (step S11: YES), the relay processing unit 10 starts timing (step S12). The relay processing unit 10 determines whether or not a first predetermined time T1 elapses since the start of timing (step S13). The first predetermined time T1 is a longest time during which a link-up PHY unit 21 does not transmit a signal. That is, the relay processing unit 10 determines whether or not the master ECU 2 is in a link-down sleep state.

Note that the relay processing unit 10 that executes the processing of steps S11 and S13 functions as a determination processing unit that determines whether or not the ECU 2 that is the second in-vehicle communication device is in the link-down sleep state.

When it is determined that the first predetermined time T1 does not elapses (step S13: NO), the relay processing unit 10 returns the processing to step S13 and waits. When it is determined that the first predetermined time T1 elapses (step S13: YES), that is, when it is confirmed that the ECU 2 is in the sleep state, as illustrated in FIG. 3, the relay processing unit 10 causes the PHY unit 11 of the relay device 1 to start outputting the predetermined signal A (step S14). The predetermined signal A is input to the PHY unit 21 of the ECU 2 via the port 1a.

The relay processing unit 10 determines whether or not a second predetermined time T2 elapses after the output of the predetermined signal A starts (step S15). The second predetermined time T2 is a time required for the detection device on the master side to reliably detect the predetermined signal A. When it is determined that the second predetermined time T2 does not elapses (step S15: NO), the relay processing unit 10 returns the processing to step S15 and waits.

When it is determined that the second predetermined time T2 elapses (step S15: YES), as illustrated in FIG. 3, the relay processing unit 10 suspends the output of the predetermined signal A (step S16), and ends the processing.

On the other hand, the detection circuit 21b of the ECU 2 detects the predetermined signal A output from the slave relay device 1 (step S21). When the detection circuit 21b detects the predetermined signal A, the predetermined power supply instruction signal is output to the power supply circuit 22. The power supply circuit 22 starts supplying electric power to the communication circuit 21a (step S22). The communication circuit 21a of the ECU 2 wakes up by feeding electric power (step S23) and links up (step S24). Thereafter, the ECU 2 starts required communication as the master in-vehicle communication device.

According to the embodiment configured in this way, it is possible to wake up the master ECU 2 in the sleep state from the slave relay device 1 compliant with 100Base-T1 related to Ethernet®.

The slave relay device 1 has a configuration in which a pattern signal substantially the same as the idle signal transmitted from the master side is output as the predetermined signal A to the master ECU 2 to wake up the PHY unit 21. Since the detection circuit 21b is configured to detect an idle signal, the detection circuit 21b can reliably detect the predetermined signal A substantially the same as the idle signal. Therefore, by using the predetermined signal A substantially the same as the idle signal, the master ECU 2 can more reliably detect the predetermined signal A transmitted from the slave and wake up the PHY unit 21 of the master.

As illustrated in FIG. 3, the relay device 1 is configured not to output the predetermined signal A to the ECU 2 until the first predetermined time T1 elapses and it is confirmed that the ECU 2 is in the sleep state. Therefore, it is possible to avoid an unexpected problem caused by outputting the predetermined signal A to the link-up ECU 2.

As illustrated in FIG. 3, when it is confirmed that the ECU 2 is in the sleep state, the relay device 1 can reliably wake up the PHY unit 21 of the ECU 2 by outputting the predetermined signal A at the second predetermined time T2.

### Second Embodiment

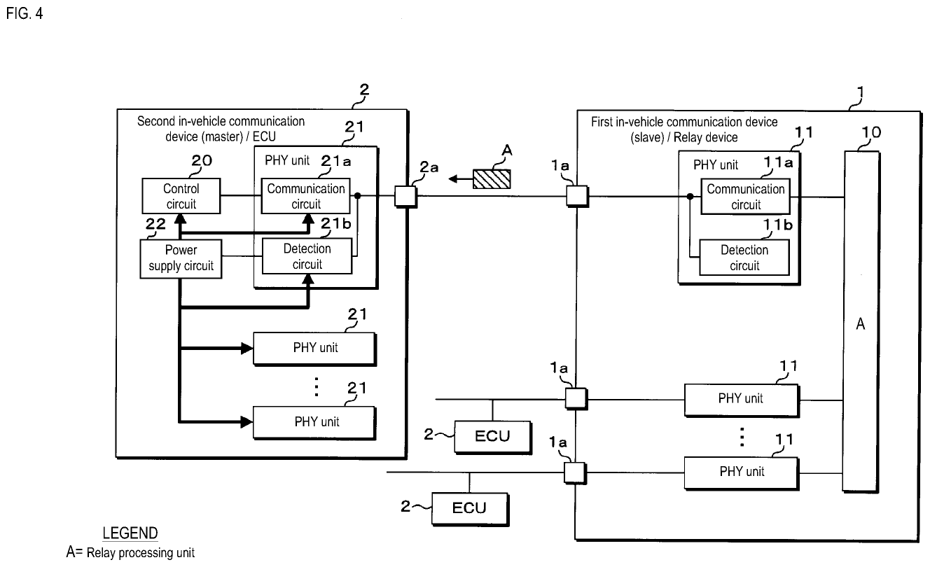

FIG. 4 is a block diagram illustrating a configuration example of an in-vehicle communication system according to a second embodiment. The in-vehicle communication system according to the second embodiment includes a relay device 1 similar to that of the first embodiment and a plurality of ECUs 2. Each of the ECUs 2 according to the second embodiment is different from that of the first embodiment in that the ECU 2 includes a plurality of PHY units 21. Note that in FIG. 4, another in-vehicle communication device such as an ECU 2 connected to the PHY unit 21 of the ECU 2 is not illustrated for convenience of drawing. A power supply circuit 22 supplies electric power to the plurality of PHY units 21.

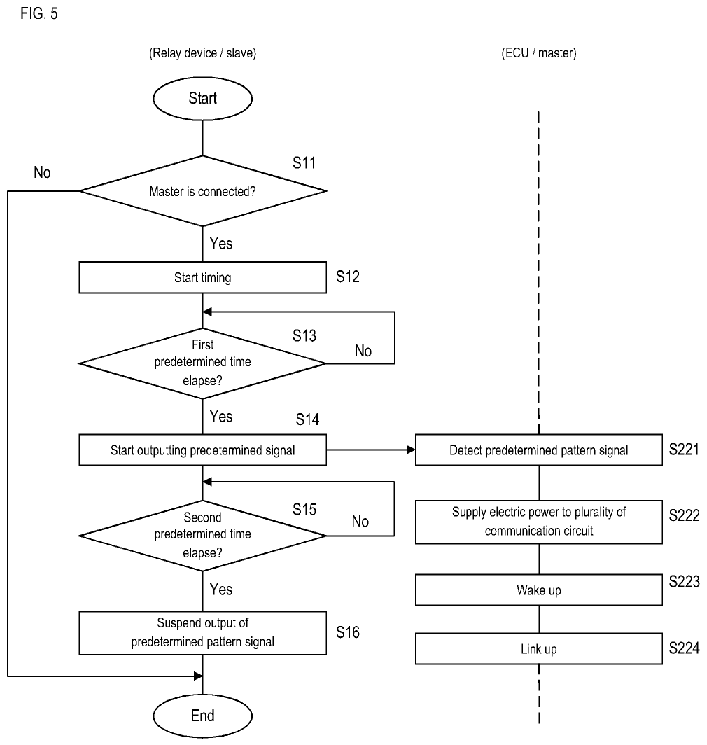

FIG. 5 is a flowchart illustrating a wake-up method of a master according to the second embodiment. Processing content of the relay device 1 which is the master is similar to that of the first embodiment.

Meanwhile, a detection circuit 21b of the ECU 2 detects a predetermined signal A output from a slave relay device 1 (step S221). When the detection circuit 21b detects the predetermined signal A, a predetermined power supply instruction signal is output to the power supply circuit 22. The power supply circuit 22 starts supplying electric power to a communication circuit 21a of a PHY unit 21 detecting the predetermined signal A and a communication circuit 21a of another PHY unit 21 or a plurality of other PHY units 21 (step S222). Each communication circuit 21a of the ECU 2 wakes up by feeding electric power (step S223) and links up (step S224). Thereafter, the ECU 2 starts required communication as the master in-vehicle communication device. Note that the power supply circuit 22 may start supplying electric power to and wake up the communication circuits 21a of all the PHY units 21 of the ECU 2, or may wake up some of the communication circuits 21a. The power supply circuit 22 may be configured to wake up another different communication circuit 21a or a plurality of different communication circuits 21a depending on the PHY unit 21 to which the predetermined signal A is input. In this case, it is preferable to provide a table in which the PHY unit 21 to which the predetermined signal A is input and the one or plurality of communication circuits 21a to be woken up are associated with each other. The power supply circuit 22 can wake up the communication circuit 21a according to the table.

According to the embodiment configured in this way, when the ECU 2 detects the predetermined signal A output from the relay device 1, the ECU 2 can wake up not only the communication circuit 21a of the PHY unit 21 to which the predetermined signal A is input but also the communication circuit 21a of another PHY unit 21 or the plurality of other PHY units 21 together. Therefore, it is unnecessary to individually wake up each of the communication circuits 21a of the plurality of PHY units 21 included in the ECU 2, and the plurality of PHY units 21 can be woken up together.

1. An in-vehicle communication system, comprising:
a first in-vehicle communication device and a second in-vehicle communication device transmitting and receiving a signal to and from each other by a predetermined communication protocol related to Ethernet®,
wherein the first in-vehicle communication device includes:
a port, a signal being input to and output from the port,
a first PHY unit having a first communication circuit for transmitting and receiving a signal via the port, and
a determination processing unit for determining whether or not the second in-vehicle communication device is in a link-down sleep state,
when the determination processing unit determines that the second in-vehicle communication device is in the sleep state, the first PHY unit outputs a predetermined signal to the second in-vehicle communication device via the port,
the second in-vehicle communication device includes:
a port, a signal being input to and output from the port,
a second PHY unit having a second communication circuit for transmitting and receiving a signal via the port,
a detection circuit for detecting the predetermined signal input to the port, and
a power supply circuit for waking up the second communication circuit when the detection circuit detects the predetermined signal,
and wherein the second in-vehicle communication device further includes a plurality of second PHY units,
a table in which one of the second PHY units is associated with a communication circuit of another second PHY unit or a plurality of other second PHY units to be woken up is provided, and
when the detection circuit detects the predetermined signal input to the port of the one second PHY unit, the power supply circuit wakes up the communication circuits of the one second PHY unit and another second PHY unit or the plurality of other second PHY units according to the table.

2. The in-vehicle communication system according to claim 1, wherein the predetermined communication protocol is 100Base-T1, the first in-vehicle communication device is a slave in the predetermined communication protocol, and the second in-vehicle communication device is a master in the predetermined communication protocol.

3. The in-vehicle communication system according to claim 2, wherein the predetermined signal is a pattern signal substantially the same as an idle signal in the predetermined communication protocol.

4. The in-vehicle communication system according to claim 1, wherein when no signal is received from the second in-vehicle communication device for a first predetermined time, the determination processing unit determines that the second in-vehicle communication device is in a sleep state, and
the first PHY unit outputs the predetermined signal during a second predetermined time related to reception of the predetermined signal by the detection circuit.

5. The in-vehicle communication system according to claim 1, wherein the first in-vehicle communication device is a relay device.

6. (canceled)

7. An in-vehicle communication device, comprising:
a port, a signal being input to and output from the port;
a PHY unit having a communication circuit for transmitting and receiving a signal via the port;
a detection circuit for detecting a predetermined signal input to the port; and
a power supply circuit for waking up the communication circuit when the detection circuit detects the predetermined signal,
wherein the in-vehicle communication device further comprises:
a plurality of second PHY units,
a table in which one of the PHY units is associated with a communication circuit of another PHY unit or a plurality of other PHY units to be woken up is provided, and
when the detection circuit detects the predetermined signal input to a port of the one PHY unit, the power supply circuit wakes up the communication circuits of the one PHY unit and another PHY unit or the plurality of other PHY units according to the table.

8. A vehicle communication method using a first in-vehicle communication device and a second in-vehicle communication device transmitting and receiving a signal to and from each other by a predetermined communication protocol related to Ethernet®, the second in-vehicle communication device including a plurality of PHY units having communication circuits transmitting and receiving signals,
wherein the first in-vehicle communication device
determines whether or not the second in-vehicle communication device is in a link-down sleep state, and
outputs a predetermined signal to the second in-vehicle communication device when it is determined that the second in-vehicle communication device is in a sleep state, and
the second in-vehicle communication device
detects the predetermined signal input to a port of one of the PHY units, and
wakes up communication circuits of the one PHY unit and another PHY unit or a plurality of other PHY units according to a table in which the one PHY unit is associated with a communication circuit of another PHY unit or a plurality of other PHY units to be woken up when the predetermined signal is detected.

9. The in-vehicle communication system according to claim 2, wherein when no signal is received from the second in-vehicle communication device for a first predetermined time, the determination processing unit determines that the second in-vehicle communication device is in a sleep state, and
the first PHY unit outputs the predetermined signal during a second predetermined time related to reception of the predetermined signal by the detection circuit.

10. The in-vehicle communication system according to claim 2, wherein when no signal is received from the second in-vehicle communication device for a first predetermined time, the determination processing unit determines that the second in-vehicle communication device is in a sleep state, and
the first PHY unit outputs the predetermined signal during a second predetermined time related to reception of the predetermined signal by the detection circuit.

11. The in-vehicle communication system according to claim 2, wherein the first in-vehicle communication device is a relay device.

12. The in-vehicle communication system according to claim 3, wherein the first in-vehicle communication device is a relay device.

13. The in-vehicle communication system according to claim 4, wherein the first in-vehicle communication device is a relay device.
